(19) United States
(12) Patent Application Publication
(10) Pub. No.: US 2023/0143741 A1
(43) Pub. Date: May 11, 2023

(54) REMOTE MONITORING SYSTEM, APPARATUS, AND METHOD

(71) Applicant: NEC Corporation, Minato-ku, Tokyo (JP)

(72) Inventors: Takanori IWAI, Tokyo (JP); Koichi NIHEI, Tokyo (JP); Kosei KOBAYASHI, Tokyo (JP); Yusuke SHINOHARA, Tokyo (JP); Masayuki SAKATA, Tokyo (JP); Takashi YAMANE, Tokyo (JP)

(73) Assignee: NEC Corporation, Minato-ku, Tokyo (JP)

(21) Appl. No.: 17/910,413

(22) PCT Filed: Mar. 31, 2020
(86) PCT No.: PCT/JP2020/014945

§ 371 Date: Sep. 9, 2022

(51) Int. Cl. G06V 20/56; G06V 20/54; G06V 10/25; H04N 5/14

(52) U.S. Cl. CPC G06V 20/56; G06V 10/25; G06V 20/54; H04N 5/145; G06V 2201/07

(57) ABSTRACT

A video reception unit obtains a first video and a second video that are different in an imaging position from each other. An important video determination unit determines a video having a higher degree of importance on the basis of the first video and the second video. A video adjustment report unit transmits a transmission video adjustment report that is used to adjust qualities of the first video and the second video in accordance with a result of determining a degree of importance. A first video adjustment unit adjusts the first video on the basis of the transmission video adjustment report. A second video adjustment unit adjusts the second video on the basis of the transmission video adjustment report.

### TECHNICAL FIELD

The present disclosure relates to a remote monitoring system, an apparatus, a method, and a computer-readable medium.

### BACKGROUND ART

In recent years, technologies relating to automated vehicles have been attracting attention. Automated driving is classified into a plurality of levels, level 1 at which a vehicle performs driving assistance to level 5 at which a vehicle travels in a completely autonomous manner. In a case where a vehicle travels in a completely autonomous manner, no driver needs to be in the vehicle. However, in a case where no driver is in the vehicle, if autonomous driving becomes unavailable, there is a possibility that the vehicle will remain at a standstill and will fail to move. In particular, in a case where an automated vehicle is made to travel without a driver, it is considered that remote monitoring of the vehicle is important.

As a related art, Patent Literature 1 discloses a monitoring apparatus that monitors a moving target. The monitoring apparatus described in Patent Literature 1 receives image data from an on-road camera installed in a parking lot, an intersection, or the like and a plurality of vehicles on which a camera is mounted. The monitoring apparatus obtains a position and a direction of movement of a target to be monitored, by using the on-road camera (a fixed camera). The monitoring apparatus selects a vehicle for monitoring the target to be monitored from among a plurality of vehicles on the basis of the position of the target to be monitored and a position of each of the vehicles. The monitoring apparatus monitors a specified target in a region to be monitored, by using image data obtained from a camera of the selected vehicle and the on-road camera.

As another related art, Patent Literature 2 discloses a remote operation system that remotely operates a vehicle. In the remote operation system described in Patent Literature 2, a camera is mounted on a vehicle, and the vehicle transmits a video captured by the camera to a remote operation apparatus. The remote operation apparatus includes a steering wheel, an accelerator pedal, a brake pedal, and the like. The remote operation apparatus displays the video received from the vehicle. A person who performs remote maneuvering operates the steering wheel or the like while viewing the video, and remotely drives the vehicle. Patent Literature 2 also describes that in a case where the vehicle is in a field of view of a fixed-point camera such as an on-road camera, the remote operation apparatus obtains a video from the fixed-point camera, and presents the video obtained from the fixed-point camera to a remote operator.

As yet another related art, Patent Literature 3 discloses a vehicle communication apparatus that is used in communication between a vehicle and a control center. In Patent Literature 3, the control center performs control to assist an automated vehicle in traveling. The vehicle includes cameras that image a front side, a rear side, a right-hand side, a left-hand side, and an interior of the vehicle. The vehicle communication apparatus transmits, to the control center, pieces of image data of front, rear, left-hand side, right-hand side, and in-vehicle cameras.

The vehicle communication apparatus specifies a situation of the vehicle by using information relating to the cameras. The vehicle communication apparatus determines priority orders of the front, rear, left-hand side, right-hand side, and in-vehicle cameras on the basis of the specified situation. The vehicle communication apparatus controls a resolution and a frame rate of image data of each of the cameras in accordance with the determined priority orders. For example, in a case where a camera that images a front side of the vehicle has a high priority order, the vehicle communication apparatus transmits, to the control center, image data of the camera that images the front side of the vehicle at a high resolution and a high frame rate.

### Citation List

### Patent Literature

Patent Literature 1: Japanese Unexamined Patent Application Publication No. 2017-216575
Patent Literature 2: International Patent Publication No. WO2018/087879
Patent Literature 3: Japanese Unexamined Patent Application Publication No. 2020-3934

### SUMMARY OF INVENTION

### Technical Problem

In Patent Literature 1, the monitoring apparatus obtains image data from a vehicle that can monitor a target to be monitored from among a plurality of vehicles, in accordance with a position of the target to be monitored and a position of each of the plurality of vehicles. In this case, if the number of vehicles from which image data is obtained increases, there is a possibility that a communication band of a wireless communication network to be used in data transmission between vehicles and the monitoring apparatus will be insufficient. In a case where a communication band of wireless communication is insufficient, the monitoring apparatus fails to obtain image data having high image quality, and the target to be monitored fails to be correctly monitored on a side of the monitoring apparatus in some cases.

In Patent Literature 2, a vehicle is remotely operated by using a video captured by a fixed-point camera. In this case, a volume of a video to be transmitted from the vehicle to the remote operation apparatus can be reduced. However, in a case where the video of the fixed-point camera and the video of the vehicle are transmitted through the same wireless communication network, there is a possibility that a communication band will be insufficient in the wireless communication network, and a situation of the vehicle fails to be correctly grasped on a side of the remote operation apparatus.

In Patent Literature 3, image data of a specified camera from among a plurality of cameras mounted on a vehicle is transmitted with high image quality to the control center in accordance with a vehicle situation. For example, at the time of turning left, pieces of image data of a front camera and a left-hand side camera are transmitted with high image quality to the control center, and therefore the control center can more reliably control the vehicle. However, in

Patent Literature 3, the vehicle communication apparatus controls the quality of a video of the local vehicle that will be transmitted from the vehicle to the control center. In Patent Literature 3, only the video of the local vehicle is used, and therefore in some cases, a peripheral situation of the vehicle fails to be precisely grasped.

In view of the circumstances described above, it is an object of the present disclosure to provide a remote monitoring system, an apparatus, a method, and a computer-readable medium that are capable of obtaining a video that enables a situation of a vehicle to be precisely grasped on a remote side even in a limited communication band.

### Solution to Problem

In order to achieve the object described above, the present disclosure provides a remote monitoring system including: video reception means for obtaining a first video and a second video that are different in an imaging position from each other; important video determination means for determining a video having a higher degree of importance on the basis of the first video and the second video; video adjustment report means for transmitting a transmission video adjustment report that is used to adjust qualities of the first video and the second video in accordance with a result of determining a degree of importance; first video adjustment means for adjusting the first video on the basis of the transmission video adjustment report; and second video adjustment means for adjusting the second video on the basis of the transmission video adjustment report.

The present disclosure provides a remote monitoring apparatus including: video reception means for obtaining a first video and a second video that are different in an imaging position from each other; important video determination means for determining a video having a higher degree of importance on the basis of the first video and the second video; and video adjustment report means for transmitting a transmission video adjustment report to adjust qualities of the first video and the second video, the transmission video adjustment report being used to adjust the qualities of the first video and the second video on the basis of a result of determining a degree of importance.

The present disclosure provides a remote monitoring method including: obtaining a first video and a second video that are different in an imaging position from each other; determining a video having a higher degree of importance on the basis of the first video and the second video; and transmitting a transmission video adjustment report to adjust qualities of the first video and the second video, the transmission video adjustment report being used to adjust the qualities of the first video and the second video in accordance with a result of determining a degree of importance.

The present disclosure provides a non-transitory computer-readable medium configured to store a program that causes a computer to perform a process including: obtaining a first video and a second video that are different in an imaging position from each other; determining a video having a higher degree of importance on the basis of the first video and the second video; and transmitting a transmission video adjustment report to adjust qualities of the first video and the second video, the transmission video adjustment report being used to adjust the qualities of the first video and the second video in accordance with a result of determining a degree of importance.

### Advantageous Effects of Invention

A remote monitoring system, an apparatus, a method, and a computer-readable medium according to the present disclosure can obtain a video that enables a situation of a vehicle to be precisely grasped on a remote side even in a limited communication band.

### BRIEF DESCRIPTION OF DRAWINGS

FIG. 1 is a block diagram schematically illustrating a remote monitoring system according to the present disclosure.

FIG. 2 is a flowchart schematically illustrating an operation procedure in the remote monitoring system according to the present disclosure.

FIG. 3 is a block diagram illustrating a remote monitoring system according to an example embodiment of the present disclosure.

FIG. 4 is a block diagram illustrating an example of a configuration of a communication device.

FIG. 5 is a block diagram illustrating an example of a configuration of a remote monitoring apparatus.

FIG. 6 is a diagram schematically illustrating a situation of an intersection in a certain phase.

FIG. 7 is a diagram schematically illustrating a situation of the intersection in another phase.

FIG. 8 is a flowchart illustrating an operation procedure in the remote monitoring system.

FIG. 9 is a block diagram illustrating an example of a configuration of a computer apparatus.

### EXAMPLE EMBODIMENT

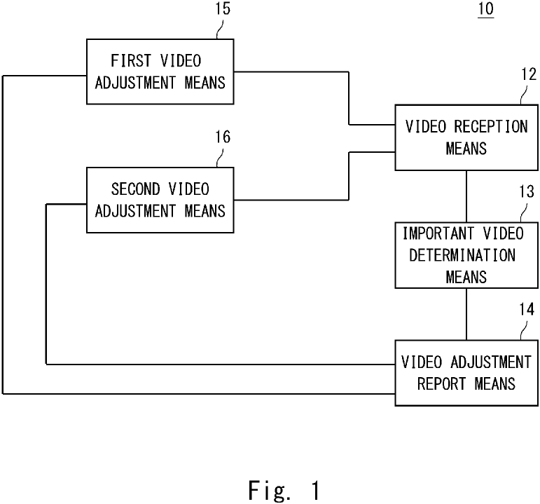

Prior to the description of an example embodiment of the present disclosure, an outline of the present disclosure is described. FIG. 1 schematically illustrates a remote monitoring system according to the present disclosure. A remote monitoring system 10 includes video reception means 12, important video determination means 13, video adjustment report means 14, first video adjustment means 15, and second video adjustment means.

In the remote monitoring system 10, the first video adjustment means 15 and the second video adjustment means 16 are disposed, for example, in a moving body such as an automobile, a bus, or a train, or an on-road facility such as a traffic light. The video reception means 12, the important video determination means 13, and the video adjustment report means 14 are disposed, for example, in a remote monitoring apparatus that remotely monitors a vehicle.

The moving body and the on-road facility in which the first video adjustment means 15 and the second video adjustment means 16 are disposed include an imaging device. The moving body and the on-road facility transmit a video captured by using the imaging device to the video reception means 12 via a network. The video reception means 12 receives the video from the vehicle, the on-road facility, and the like. The video reception means 12 obtains a first video and a second video that are different in an imaging position from each other.

The important video determination means 13 determines a video having a higher degree of importance on the basis of the first video and the second video. The video adjustment report means 14 transmits a transmission video adjustment report that is used to adjust the qualities of the first video and the second video in accordance with a result of determining a degree of importance.

The first video adjustment means 15 adjusts the quality of the first video on the basis of the transmission video adjustment report. The second video adjustment means 16 adjusts the quality of the second video on the basis of the transmission video adjustment report. To adjust quality means, for example, to adjust image quality, and means to adjust at least one of a compression ratio, a resolution, or a rate to adjust an amount of data. The video reception means 12 receives the first video and the second video in which quality has been adjusted. As an example of the adjustment of quality, it is conceivable that the video adjustment means increases the quality of an important region, or reduces the quality of a region other than the important region. Examples of increasing quality include an operation to increase a resolution of a video (sharpening), an operation to increase the number of frames, and other operations.

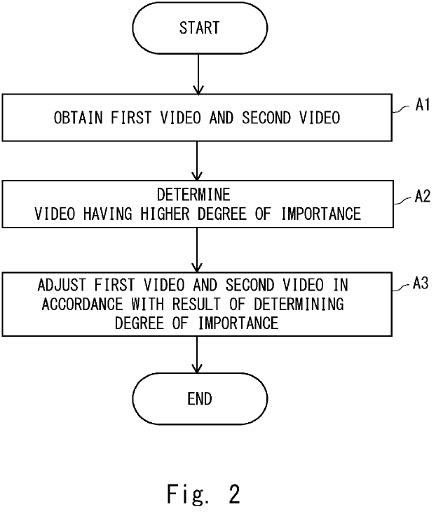

FIG. 2 schematically illustrates an operation procedure in the remote monitoring system 10. The video reception means 12 obtains a first video and a second video that are different in an imaging position from each other (step A1). The important video determination means 13 determines a video having a higher degree of importance on the basis of the first video and the second video (step A2). The video adjustment report means 14 transmits a transmission video adjustment report that is used to adjust the qualities of the first video and the second video in accordance with a result of determining a degree of importance, and therefore the qualities of the first video and the second video are adjusted (step A3).

In the present disclosure, the important video determination means 13 determines a video having a higher degree of importance. The video adjustment report means 14 generates and transmits a transmission video adjustment report in accordance with a result of determining a degree of importance. The first video adjustment means 15 and the second video adjustment means 16 respectively adjust the qualities of the first video and the second video on the basis of the transmission video adjustment report. By doing this, the video reception means 12 can receive a video having a quality that corresponds to a degree of importance of the video, and can obtain a video that enables a situation of a vehicle to be precisely grasped in a limited communication band.

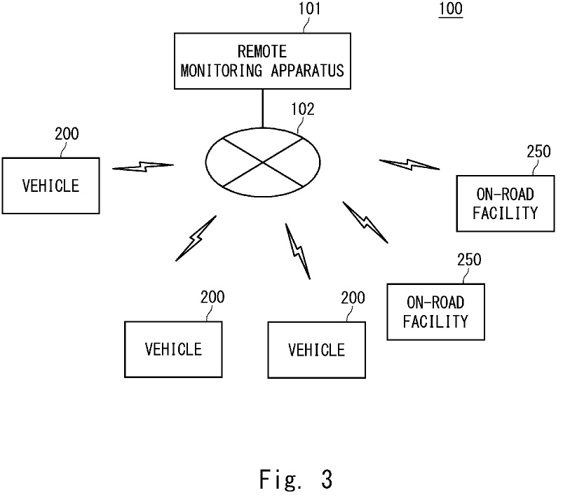

An example embodiment of the present disclosure is described in detail below with reference to the drawings. FIG. 3 illustrates a remote monitoring system according to an example embodiment of the present disclosure. A remote monitoring system 100 includes a remote monitoring apparatus 101, a plurality of vehicles 200, and a plurality of on-road facilities 250. In the remote monitoring system 100, the remote monitoring apparatus 101 performs communication with the vehicles 200 and the on-road facilities 250 via a network 102. The network 102 includes a wireless communication network such as a fifth generation mobile communication system.

Each of the vehicles 200 and the on-road facilities 250 includes a camera. A single vehicle 200 and a single on-road facility 250 may include a plurality of cameras. The vehicle 200 is, for example, a vehicle that travels on the road, such as a private car, a taxi, or a bus. The on-road facility 250 is a facility that has been installed on the road, such as a traffic light, a traffic sign, or a street light. Each of the vehicles 200 and the on-road facilities 250 includes a communication device that transmits, to the remote monitoring apparatus 101, a video captured by using the camera. The remote monitoring apparatus 101 receives the video from the vehicles 200 and the on-road facilities 250 via the network 102.

Note that FIG. 3 illustrates three vehicles 200 and two on-road facilities 250, but the present example embodiment is not limited to this. In the present example embodiment, it is sufficient if the remote monitoring apparatus 101 can receive the video from two or more targets, and the number of vehicles 200 and the number of on-road facilities 250 are not particularly limited. For example, the remote monitoring apparatus 101 may receive the video from a single vehicle 200 and a single on-road facility 250. Alternatively, the remote monitoring apparatus 101 may receive the video from a plurality of vehicles 200, and may receive the video from a plurality of on-road facilities 250. At least some of the plurality of vehicles 200 may be configured to be able to perform automated driving (autonomous driving).

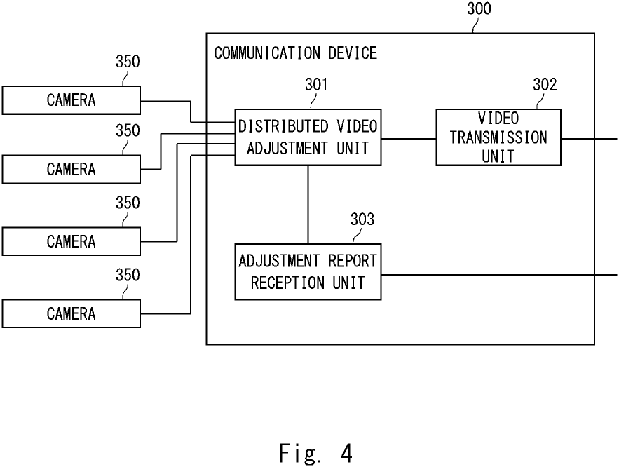

FIG. 4 illustrates an example of a configuration of a communication device included in the vehicle 200 and the on-road facility 250. The vehicle 200 and the on-road facility 250 include a communication device 300 and a camera 350. The communication device 300 includes a distributed video adjustment unit 301, a video transmission unit 302, and an adjustment report reception unit 303. Note that FIG. 4 illustrates four cameras 350, but the number of cameras 350 is not limited to four. It is sufficient if the vehicle 200 and the on-road facility 250 include at least a single camera 350.

Each of the cameras 350 images an outside of the vehicle or the on-road facility, and outputs image data (a video) to the communication device 300. In the vehicle, each of the cameras 350 images, for example, a front side, a rear side, a right-hand side, or a left-hand side of the vehicle. In the on-road facility such as a traffic light, each of the cameras 350 images an intersection in which the traffic light has been installed from a plurality of directions. The communication device 300 transmits a video captured by using the camera 350 to the remote monitoring apparatus 101 via the network 102 (see FIG. 3).

The distributed video adjustment unit 301 adjusts the qualities of videos captured by using the plurality of cameras 350. Here, to adjust the quality of a video means to adjust, for example, at least some of a compression ratio, a resolution, or a frame rate of a video of each of the cameras 350, and means to adjust an amount of data of a video to be transmitted to the remote monitoring apparatus 101 via the network 102. As an example of the adjustment of quality, it is conceivable that the distributed video adjustment unit 301 increases the quality of an important region, or reduces the quality of a region other than the important region. Examples of increasing quality include an operation to increase a resolution of a video (sharpening), an operation to increase the number of frames, and other operations. The adjustment report reception unit 303 receives a transmission video adjustment report from the remote monitoring apparatus 101 via the network 102. Determination of the transmission video adjustment report in the remote monitoring apparatus 101 will be described later.

In a case where the transmission video adjustment report has been received, the adjustment report reception unit 303 reports the transmission video adjustment report to the distributed video adjustment unit 301. The distributed video adjustment unit 301 adjusts the quality of a video of each of the cameras 350 that will be transmitted to the remote monitoring apparatus 101, on the basis of the transmission video adjustment report. For example, the distributed video adjustment unit 301 performs adjustment in such a way that the quality of a video that has been designated as a video having a higher degree of importance in the transmission video adjustment report is higher than the quality of another video.

The video transmission unit 302 transmits a video of each of the cameras 350 in which quality has been adjusted by the distributed video adjustment unit 301, to the remote monitoring apparatus 101 via the network 102. The video transmission unit 302 corresponds to the video transmission means 11 illustrated in FIG. 1, and the distributed video adjustment unit 301 corresponds to the first video adjustment means 15 or the second video adjustment means 16 that is illustrated in FIG. 1.

Note that in the present example embodiment, it is assumed that videos that are transmitted from the vehicle 200 and the on-road facility 250 to the remote monitoring apparatus 101 are two-dimensional camera images. However, the video is not particularly limited to a two-dimensional image, if a peripheral situation can be grasped. For example, a video transmitted from the vehicle 200 to the remote monitoring apparatus 101 can include a point cloud image that has been generated by using light detection and ranging (LiDAR) or the like.

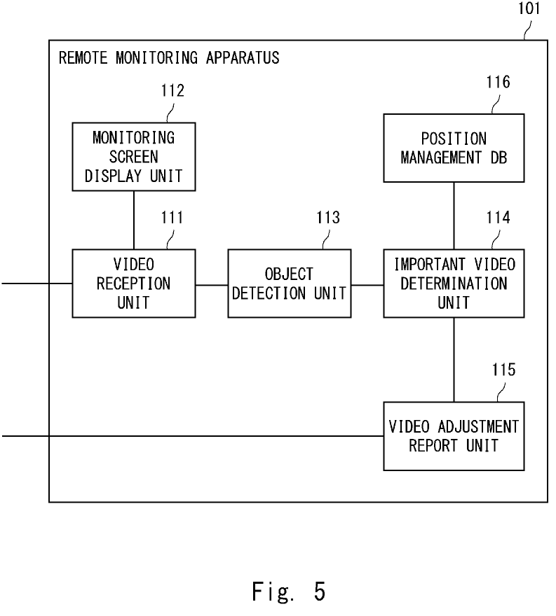

FIG. 5 illustrates an example of a configuration of the remote monitoring apparatus 101. The remote monitoring apparatus 101 includes a video reception unit 111, a monitoring screen display unit 112, an object detection unit 113, an important video determination unit 114, a video adjustment report unit 115, and a position management DB 116. In the position management DB 116, positional information relating to an obtaining source (a camera) of each video is managed. The remote monitoring apparatus 101 obtains positional information, for example, from the vehicle 200, and a position of each of the vehicles is managed in the position management DB 116. Positional information relating to the on-road facility 250 is stored in the position management DB 116, for example, by an administrator. Positional information may be obtained from the on-road facility 250, and the positional information may be stored in the position management DB 116. In the position management DB 116, information relating to an imaging range of each of the cameras may be stored.

The video reception unit 111 receives, via the network 102 (see FIG. 3), videos that have been transmitted from the vehicle 200 and the on-road facility 250. The monitoring screen display unit 112 displays the video received by the video reception unit 111. The video reception unit 111 receives, for example, a video captured by a camera of a vehicle 200 to be monitored and a video captured by a camera of a related object that relates to the vehicle to be monitored. The related object that relates to the vehicle to be monitored includes a vehicle other than the vehicle to be monitored, and the on-road facility.

The monitoring screen display unit 112 displays, on a display screen, for example, videos that have been imaged by using the cameras 350 (see FIG. 4) mounted on the vehicle 200 to be monitored, and indicate a front side, a rear side, a right-hand side, and a left-hand side of the vehicle. In addition, the monitoring screen display unit 112 displays, on the display screen, videos that have been received from a vehicle 200 other than the vehicle to be monitored, and the on-road facility 250. A monitoring person monitors the display screen to determine whether the traveling of the vehicle to be monitored will be hindered.

The object detection unit (object detection means) 113 detects an object included in the video. The object detection unit 113 detects, for example, a person, another vehicle, a fallen object on the road (an obstacle), or the like that is included in the video. The important video determination unit 114 determines a video having a higher degree of importance (an important video) from among videos received by the video reception unit 111. The important video determination unit 114 determines the important video, for example, on the basis of a result of object detection performed by the object detection unit 113. The important video determination unit 114 corresponds to the important video determination means 13 illustrated in FIG. 1.

The video adjustment report unit 115 generates a transmission video adjustment report for each of the videos, on the basis of a result of determination performed by the important video determination unit 114. The transmission video adjustment report includes, for example, information that identifies each of the videos, and information that designates at least one of a compression ratio, a resolution, or a transmission period (a frame rate) of the video. The video adjustment report unit 115 generates a transmission video adjustment report that designates, for example, a higher resolution and a higher frame rate, for a video that has been determined to be an important video. The video adjustment report unit 115 generates a transmission video adjustment report that designates a lower resolution and a lower frame rate, for a video that has not been determined to be an important video.

The video adjustment report unit 115 transmits the transmission video adjustment report via the network to a vehicle 200 and an on-road facility 250 that serve as a video transmission source. In the vehicle 200 and the on-road facility 250, the adjustment report reception unit 303 (see FIG. 4) of the communication device 300 receives the transmission video adjustment report. The distributed video adjustment unit 301 adjusts a resolution, a transmission period, and the like of a video of each of the cameras 350 in accordance with the transmission video adjustment report. The distributed video adjustment unit 301 adjusts the qualities of the videos on the basis of the transmission video adjustment report in such a way that the image quality of a video that has been determined to be an important video is higher than the image quality of a video that has not been determined to be an important video.

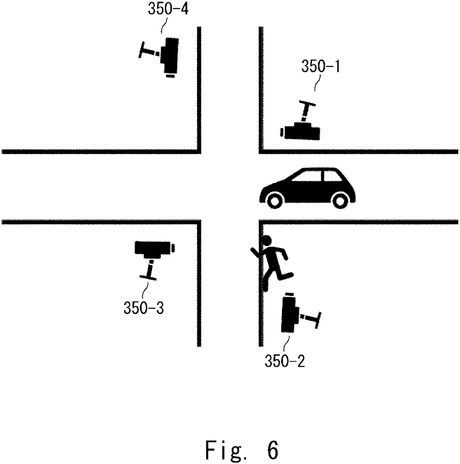

For example, in a case where the object detection unit 113 has detected an object, the important video determination unit 114 may determine that a video in which the object has been detected is an important video, and may determine that another video is not an important video. FIG. 6 schematically illustrates a situation of an intersection in which a plurality of cameras has been installed, in a certain phase. In the example of FIG. 6, in an intersection in which two roads cross each other, four cameras 350-1 to 350-4 that are different in an imaging direction from each other have been installed. In the situation illustrated in FIG. 6, in a video captured by the camera 350-1, neither persons nor vehicles have been detected. In contrast, in a video captured by the camera 350-3, a person and a vehicle have been detected. In this case, the important video determination unit 114 determines that the video of the camera 350-3 is a video that is more important than the video of the camera 350-1. The video adjustment report unit 115 designates a higher resolution and a higher frame rate for the camera 350-3, in the transmission video adjustment report. The video adjustment report unit 115 designates a lower resolution and a lower frame rate for the camera 350-1, in the transmission video adjustment report. The distributed video adjustment unit 301 adjusts the quality of each of the videos on the basis of such a transmission video adjustment report in such a way that the quality of the video of the camera 350-3 is higher than the quality of the video of the camera 350-1.

In a case where an object has been detected, the important video determination unit 114 may estimate a direction of movement of the object. The important video determination unit 114 may refer to the position management DB 116, may specify a camera having an imaging range that an estimated destination of movement of the object falls within, may determine that a video of the camera is an important video, and may determine that another video is not an important video. For example, in the situation illustrated in FIG. 6, the important video determination unit 114 estimates that a person that has been detected in the video of the camera 350-2 will cross the intersection, and will move to an imaging range of the camera 350-4. In this case, the important video determination unit 114 determines that a video of the camera 350-4 is a video that is more important than a video of the camera 350-2. The video adjustment report unit 115 designates a higher resolution and a higher frame rate for the camera 350-4, in the transmission video adjustment report. The video adjustment report unit 115 designates a lower resolution and a lower frame rate for the camera 350-2, in the transmission video adjustment report. The distributed video adjustment unit 301 adjusts the quality of each of the videos on the basis of such a transmission video adjustment report in such a way that the quality of the video of the camera 350-4 is higher than the quality of the video of the camera 350-2.

The important video determination unit 114 may analyze a traffic state on the basis of videos received by the video reception unit 111 and a position indicated in each of the videos, and may determine an important video on the basis of a result of analysis. The important video determination unit 114 analyzes, for example, a risky traffic state, such as rushing out to the road of a person, crossing of a person in a place other than the crosswalk, a construction site, or congestion of persons or vehicles, in a specified position. The important video determination unit 114 may determine that a video used to analyze a risky traffic state around a current location of a vehicle 200 to be monitored or on an expected traveling route is an important video. In this case, the video adjustment report unit 115 designates a higher resolution and a higher frame rate for the video used to analyze the risky traffic state, in the transmission video adjustment report. The distributed video adjustment unit 301 adjusts the quality of each of the videos on the basis of the transmission video adjustment report in such a way that the quality of the video used to analyze the risky traffic state is higher than the quality of another video.

The important video determination unit 114 may determine whether a plurality of vehicles is traveling in a platoon. Whether a plurality of vehicles is traveling in a platoon can be determined on the basis of, for example, videos of the plurality of vehicles and pieces of positional information of the plurality of vehicles. For example, the position management DB 116 manages information indicating relevance among cameras of the plurality of vehicles, for example, information indicating which vehicles are traveling in a platoon. The important video determination unit 114 may refer to the position management DB 116, and may recognize the plurality of vehicles that are traveling in a platoon.

In a case where it has been determined that a plurality of vehicles is traveling in a platoon, the important video determination unit 114 may determine an important video in accordance with a position in a platoon of each of the vehicles that are traveling in a platoon. For example, the important video determination unit 114 determines that a video indicating a front side of a vehicle that is traveling at the head of the platoon and a video indicating a rear side of a vehicle that is traveling in the end of the platoon are important videos. In addition, the important video determination unit 114 determines that videos indicating left-hand and right-hand sides of each of the vehicles in the middle of the platoon (vehicles other than the vehicles located at the head and in the end of the platoon) are important videos. In a case where a plurality of vehicles is traveling in a platoon, the monitoring screen display unit 112 may display videos in a platoon units rather than in vehicle units. The monitoring screen display unit 112 may display, for example, a video indicating a front side of a vehicle that is traveling at the head of the platoon and a video indicating a rear side of a vehicle that is traveling in the end of the platoon as videos indicating front and rear sides of the platoon. In addition, the monitoring screen display unit 112 may display videos indicating left-hand and right-hand sides of a vehicle in the middle of the platoon as videos indicating left-hand and right-hand sides of the platoon.

The important video determination unit 114 may determine whether a vehicle to be monitored will pass another vehicle. Alternatively, the important video determination unit 114 may determine whether a vehicle to be monitored will be passed by another vehicle. Passing can be determined on the basis of at least one of a video of a vehicle that will pass another vehicle or a video of the other vehicle that will be passed by the vehicle. Alternatively, passing can be determined according to a positional relationship between vehicles. The important video determination unit 114 may determine an important video in accordance with whether a vehicle to be monitored will pass another vehicle or will be passed by the other vehicle.

In a case where a vehicle to be monitored will pass another vehicle, the important video determination unit 114 determines that a video indicating a front side of the vehicle to be monitored is an important video. In this case, the video adjustment report unit 115 designates a higher resolution and a higher frame rate for a video of a camera that images the front side of the vehicle to be monitored, in the transmission video adjustment report. The video adjustment report unit 115 designates a lower resolution and a lower frame rate for a video of another camera that images a rear side, a left-hand side, or a right-hand side of the vehicle to be monitored, in the transmission video adjustment report. The distributed video adjustment unit 301 adjusts the quality of each of the videos on the basis of such a transmission video adjustment report in such a way that the quality of the video of the camera that images the front side of the vehicle to be monitored is higher than the quality of a video of another camera.

In a case where a vehicle to be monitored will be passed by another vehicle, the important video determination unit 114 determines that a video indicating a rear side of the vehicle to be monitored is an important video. In this case, the video adjustment report unit 115 designates a higher resolution and a higher frame rate for a video of a camera that images the rear side of the vehicle to be monitored, in the transmission video adjustment report. The distributed video adjustment unit 301 adjusts the quality of each of the videos on the basis of the transmission video adjustment report in such a way that the quality of the video of the camera that images the rear side of the vehicle to be monitored is higher than the quality of a video of another camera. In addition, in a case where a video can be obtained from both a vehicle that will pass another vehicle and the other vehicle that will be passed by the vehicle, the video adjustment report unit 115 designates, for example, a higher resolution and a higher frame rate for a video indicating a front side of the vehicle that will pass the other vehicle, in the transmission video adjustment report. The video adjustment report unit 115 designates a lower resolution and a lower frame rate for a video indicating a front side of the other vehicle that will be passed by the vehicle, in the transmission video adjustment report. The distributed video adjustment unit 301 adjusts the quality of each of the videos on the basis of the transmission video adjustment report in such a way that the quality of the video indicating the front side of the vehicle that will pass the other vehicle is higher than the quality of the video indicating the front side of the other vehicle that will be passed by the vehicle.

In a case where a vehicle to be monitored will enter an intersection or the like, the important video determination unit 114 may determine that a video captured by an on-road facility 250 that has been installed near the intersection is an important video. For example, the video reception unit 111 receives a video from a vehicle 200 to be monitored and on-road facilities 250 that image a plurality of directions in an intersection. In a case where the vehicle 200 to be monitored will turn right at the intersection, the important video determination unit 114 may determine that a video that has been captured by an on-road facility 250 and indicates a road after turning right is an important video.

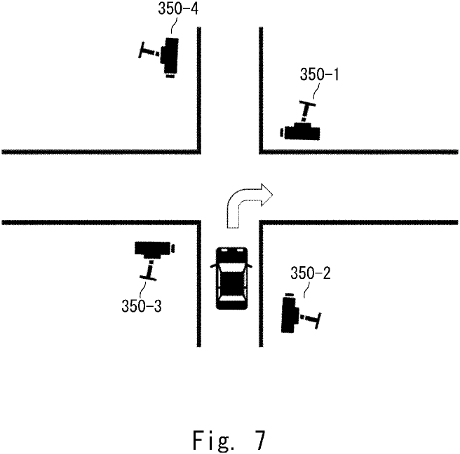

FIG. 7 schematically illustrates a situation of an intersection in which a plurality of cameras has been installed, in another phase. In this example, a vehicle will turn right at the intersection. In a case where the video reception unit 111 receives a video from a plurality of on-road facilities 250, the important video determination unit 114 may determine that from among videos received from the plurality of on-road facilities 250, a video indicating a traveling direction of a vehicle 200 to be monitored is an important video. In this case, the important video determination unit 114 determines that a video received from an on-road facility (the camera 350-2) that images the traveling direction of the vehicle is an important video. The video adjustment report unit 115 designates a higher resolution and a higher frame rate for the video of the camera 350-2, in the transmission video adjustment report. The video adjustment report unit 115 designates a lower resolution and a lower frame rate for a video of the camera 350-4, in the transmission video adjustment report. The distributed video adjustment unit 301 adjusts the quality of each of the videos on the basis of the transmission video adjustment report in such a way that the quality of the video of the camera 350-2 is higher than the quality of the video of the camera 350-4.

The important video determination unit 114 may further determine important regions in respective videos received by the video reception unit 111 on the basis of the respective videos. The important video determination unit 114 may determine, for example, that a particularly important region in a video that has been determined to be an important video is an important region. The important video determination unit 114 may determine, for example, that a region of an object detected by the object detection unit 113 is an important region. Specifically, for example, in a case where there is a person in a video, the important video determination unit 114 may determine that a region of the person is an important region. The important video determination unit 114 may determine a plurality of important regions in a single video. In a case where the important video determination unit 114 has determined an important region, the video adjustment report unit 115 includes information that designates the important region in the transmission video adjustment report. In a case where the transmission video adjustment report includes the information that designates the important region, the distributed video adjustment unit 301 may adjust video quality in such a way that in a single video, quality in the important region is higher than quality in another region.

The video adjustment report unit 115 may select whether the transmission video adjustment report will need to be transmitted. In other words, a transmission video adjustment report relating to a video that has been determined to be an important video may be transmitted, and a transmission video adjustment report relating to a video that has not been determined to be an important video may not be transmitted. For example, in a case where the transmission video adjustment report has not been received, the distributed video adjustment unit 301 on a vehicle side adjusts the quality of each video to relatively low image quality. The video adjustment report unit 115 transmits a transmission video adjustment report relating to a video that has been determined to be an important video, that is, a video to be transmitted with high image quality. The distributed video adjustment unit 301 may adjust a video for which the transmission video adjustment report has been received in accordance with the transmission video adjustment report in such a way that a resolution of the video is increased, and a transmission period is decreased. The video adjustment report unit 115 corresponds to the video adjustment report means 14 illustrated in FIG. 1.

Before the important video determination unit 114 determines an important video, a monitoring person monitors a vehicle to be monitored by using a video having relatively low image quality. In a case where the important video determination unit 114 has determined an important video, the video reception unit 111 receives a video having relatively high image quality for the video that has been determined to be the important video. In this case, a monitoring person can monitor a clear video for the important video to determine whether the traveling of a vehicle to be monitored will be hindered.

Note that the remote monitoring apparatus 101 may remotely control the traveling of a vehicle to be monitored in addition to remotely monitoring the vehicle to be monitored. For example, the remote monitoring apparatus 101 may include a remote control unit, and the remote control unit may transmit, to a vehicle, a remote control command relating to, for example, the start of turning right, emergency stop, or the like. In a case where the vehicle has received the remote control command, the vehicle operates according to the command. Alternatively, the remote monitoring apparatus 101 may include equipment for remotely maneuvering a vehicle, such as a steering wheel, an accelerator pedal, or a brake pedal. The remote control unit may remotely drive a vehicle in accordance with an operation performed on a remote driving vehicle. The remote monitoring apparatus 101 may switch a driving mode of a vehicle that is being driven in an automated driving mode to a remote driving mode. Alternatively, the remote monitoring apparatus 101 may switch a driving mode of a vehicle that is being driven by a person to the automated driving mode or the remote driving mode.

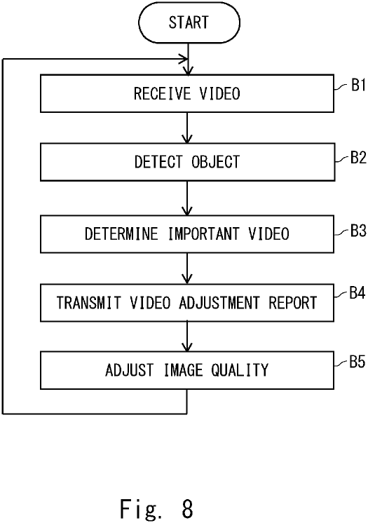

Next, an operation procedure (a remote monitoring method) in the remote monitoring system 100 is described. FIG. 8 illustrates the operation procedure in the remote monitoring system 100. Each of the vehicles 200 and the on-road facilities 250 transmits a video captured by using the camera 350 (see FIG. 4) to the remote monitoring apparatus 101 via the network 102. The video reception unit 111 of the remote monitoring apparatus 101 collects videos from the vehicles 200 and the on-road facilities 250 (step B1).

The object detection unit 113 performs object detection on each of the collected videos (step B2). The important video determination unit 114 determines an important video on the basis of a result of object detection (step B3). In step B3, the important video determination unit 114 determines that a video in which a predetermined object such as a person has been detected is an important video. Alternatively, the important video determination unit 114 may analyze a vehicle to be monitored and a traffic situation around the vehicle to be monitored by using a result of object detection, and may determine an important video on the basis of a result of analysis. The important video determination unit 114 may further determine an important region in the important video.

The video adjustment report unit 115 generates a transmission video adjustment report on the basis of a result of determining the important video. The video adjustment report unit 115 transmits the transmission video adjustment report to a vehicle 200 and an on-road facility 250 that serve as a transmission source of each of the videos (step B4). In the communication device 300 (see FIG. 4) of the vehicle 200 and the on-road facility 250, the adjustment report reception unit 303 receives the transmission video adjustment report. The distributed video adjustment unit 301 adjusts the image quality of a video obtained from each of the cameras 350 on the basis of the transmission video adjustment report received by the adjustment report reception unit 303 (step B5). The video transmission unit 302 transmits, to the remote monitoring apparatus 101, a video in which image quality has been adjusted.

In the present example embodiment, in the remote monitoring apparatus 101, the important video determination unit 114 determines an important video from among a plurality of videos received from the vehicles 200 and the on-road facilities 250. The video adjustment report unit 115 controls the distributed video adjustment unit 301 on a video transmission side in such a way that the image quality of a video that has been determined to be the important video is higher than the image quality of another video. By doing this, the video reception unit 111 can receive a video in which quality has been adjusted in such a way that an important region has high image quality. The remote monitoring apparatus 101 according to the present example embodiment can receive a video having an image quality that corresponds to a degree of importance of the video, and can obtain a video that enables a situation of a vehicle to be monitored to be precisely grasped even in a limited communication band.

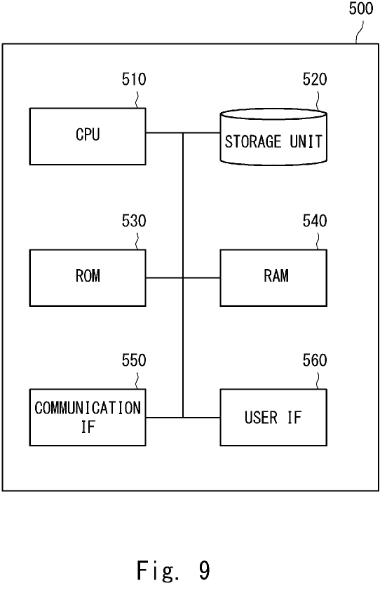

Note that, in the present disclosure, the remote monitoring apparatus 101 can be configured as a computer apparatus (a server apparatus). FIG. 9 illustrates an example of a configuration of a computer apparatus that can be used as the remote monitoring apparatus 101. A computer apparatus 500 includes a control unit (a central processing unit (CPU)) 510, a storage unit 520, a read only memory (ROM) 530, a random access memory (RAM) 540, a communication interface (IF) 550, and a user interface 560.

The communication interface 550 is an interface for connecting the computer apparatus 500 to a communication network by using wired communication means, wireless communication means, or the like. The user interface 560 includes, for example, a display unit such as a display. In addition, the user interface 560 includes an input unit such as a keyboard, a mouse, or a touch panel.

The storage unit 520 is an auxiliary storage device that can hold various types of data. The storage unit 520 does not necessarily need to be part of the computer apparatus 500, and may be an external storage device or a cloud storage connected to the computer apparatus 500 via a network.

The ROM 530 is a non-volatile storage device. As the ROM 530, for example, a semiconductor storage device, such as a flash memory, that has a relatively small capacity is used. A program executed by the CPU 510 can be stored in the storage unit 520 or the ROM 530. The storage unit 520 or the ROM 530 stores, for example, various programs for implementing a function of each unit in the remote monitoring apparatus 101.

The program described above can be stored by using various non-transitory computer-readable media, and can be supplied to the computer apparatus 500. The non-transitory computer-readable media include various tangible storage media. Examples of the non-transitory computer-readable medium include a magnetic recording medium such as a flexible disk, a magnetic tape, or a hard disk, a magneto-optical recording medium such as a magneto-optical disk, an optical disk medium such as a compact disc (CD) or a digital versatile disk (DVD), and a semiconductor memory such as a mask ROM, a programmable ROM (PROM), an erasable PROM (EPROM), a flash ROM, or a RAM. In addition, the program may be supplied to a computer by using various transitory computer-readable media. Examples of the transitory computer-readable medium include an electrical signal, an optical signal, and electromagnetic waves. The transitory computer-readable medium can supply the program to a computer via a wired communication line such as an electric wire or an optical fiber, or a wireless communication line.

The RAM 540 is a volatile storage device. As the RAM 540, various semiconductor memory devices, such as a dynamic random access memory (DRAM) or a static random access memory (SRAM), are used. The RAM 540 can be used as an internal buffer that transitorily stores data or the like. The CPU 510 deploys a program stored in the storage unit 520 or the ROM 530 in the RAM 540, and executes the deployed program. The CPU 510 executes the program, and therefore a function of each of the units in the remote monitoring apparatus 101 can be implemented. The CPU 510 may include an internal buffer in which data or the like can be transitorily stored.

An example embodiment of the present disclosure has been described in detail above. However, the present disclosure is not limited to the example embodiment described above, and the present disclosure also includes those that are obtained by making changes or modifications to the example embodiment described above without departing from the spirit of the present disclosure.

For example, all or some of the example embodiments disclosed above can be described like in, but not limited to, the following supplementary notes.

### Supplementary Note 1

A remote monitoring system including:
video reception means for obtaining a first video and a second video that are different in an imaging position from each other;
important video determination means for determining a video having a higher degree of importance on the basis of the first video and the second video;
video adjustment report means for transmitting a transmission video adjustment report that is used to adjust qualities of the first video and the second video in accordance with a result of determining a degree of importance;
first video adjustment means for adjusting the first video on the basis of the transmission video adjustment report; and
second video adjustment means for adjusting the second video on the basis of the transmission video adjustment report.

### Supplementary Note 2

The remote monitoring system according to Supplementary Note 1, in which the video adjustment report means controls the first video adjustment means and the second video adjustment means on the basis of the transmission video adjustment report to cause a video that has been determined to be the video having the higher degree of importance to have an image quality that is higher than an image quality of a video that has not been determined to be the video having the higher degree of importance.

### Supplementary Note 3

The remote monitoring system according to Supplementary Note 1 or 2, in which the first video and the second video include at least one of a video obtained in a vehicle to be monitored or a video obtained in a related object relating to the vehicle to be monitored.

### Supplementary Note 4

The remote monitoring system according to any one of Supplementary Notes 1 to 3, in which
the important video determination means further determines an important region in each video received by the video reception means on the basis of each of the videos, and
the video adjustment report means includes information that designates the important region in the transmission video adjustment report.

### Supplementary Note 5

The remote monitoring system according to any one of Supplementary Notes 1 to 4, further including object detection means for performing object detection on a video received by the video reception means,

in which the important video determination means determines the video having the higher degree of importance on the basis of a result of the object detection performed by the object detection means.

### Supplementary Note 6

The remote monitoring system according to Supplementary Note 5, in which the important video determination means estimates a destination of movement of an object that has been detected, and determines that a video having an imaging range that the destination of movement that has been estimated falls within is the video having the higher degree of importance.

### Supplementary Note 7

The remote monitoring system according to any one of Supplementary Notes 1 to 4, in which the important video determination means analyzes a state of traffic on the basis of the first video, the second video, and a plurality of the imaging positions of the first video and the second video, and determines the video having the higher degree of importance on the basis of a result of analysis.

### Supplementary Note 8

The remote monitoring system according to any one of Supplementary Notes 1 to 4, in which
the video reception means receives a plurality of videos from a plurality of vehicles to be monitored, the plurality of videos being different in an imaging position from each other, and
in a case where the plurality of vehicles to be monitored is traveling in a platoon, the important video determination means determines the video having the higher degree of importance in accordance with a position in the platoon of each of the plurality of vehicles to be monitored that is traveling in the platoon.

### Supplementary Note 9

The remote monitoring system according to Supplementary Note 8, in which the important video determination means determines that at least a video that indicates a front side of a vehicle that is traveling at a head of the platoon or a video that indicates a rear side of a vehicle that is traveling in an end of the platoon are a plurality of the videos having the higher degree of importance.

### Supplementary Note 10

The remote monitoring system according to any one of Supplementary Notes 1 to 4, in which
the video reception means receives one or more videos from respective one or more on-road facilities, and
the important video determination means determines that from among the one or more videos that have been received from the respective one or more on-road facilities, a video indicating a traveling direction of a vehicle to be monitored is the video having the higher degree of importance.

### Supplementary Note 11

A remote monitoring apparatus including:
video reception means for obtaining a first video and a second video that are different in an imaging position from each other;
important video determination means for determining a video having a higher degree of importance on the basis of the first video and the second video; and
video adjustment report means for transmitting a transmission video adjustment report to adjust qualities of the first video and the second video, the transmission video adjustment report being used to adjust the qualities of the first video and the second video on the basis of a result of determining a degree of importance.

### Supplementary Note 12

The remote monitoring apparatus according to Supplementary Note 11, in which the video adjustment report means adjusts the qualities of the first video and the second video on the basis of the transmission video adjustment report to cause a video that has been determined to be the video having the higher degree of importance to have an image quality that is higher than an image quality of a video that has not been determined to be the video having the higher degree of importance.

### Supplementary Note 13

The remote monitoring apparatus according to Supplementary Note 11 or 12, in which the first video and the second video include at least one of a video obtained in a vehicle to be monitored or a video obtained in a related object relating to the vehicle to be monitored.

### Supplementary Note 14

The remote monitoring apparatus according to any one of Supplementary Notes 11 to 13, in which
the important video determination means further determines an important region in each video received by the video reception means on the basis of each of the videos, and
the video adjustment report means includes information that designates the important region in the transmission video adjustment report.

### Supplementary Note 15

A remote monitoring method including:
obtaining a first video and a second video that are different in an imaging position from each other;
determining a video having a higher degree of importance on the basis of the first video and the second video; and
transmitting a transmission video adjustment report to adjust qualities of the first video and the second video, the transmission video adjustment report being used to adjust the qualities of the first video and the second video in accordance with a result of determining a degree of importance.

### Supplementary Note 16

The remote monitoring method according to Supplementary Note 15, in which in adjusting the qualities of the first video and the second video, the qualities of the first video and the second video are adjusted on the basis of the transmission video adjustment report to cause a video that has been determined to be the video having the higher degree of importance to have an image quality that is higher than an image quality of a video that has not been determined to be the video having the higher degree of importance.

### Supplementary Note 17

The remote monitoring method according to Supplementary Note 15 or 16, in which the first video and the second video include at least one of a video obtained in a vehicle to be monitored or a video obtained in a related object relating to the vehicle to be monitored.

### Supplementary Note 18

The remote monitoring method according to any one of Supplementary Notes 15 to 17, further including further determining an important region in each video on the basis of the first video and the second video,

generating the transmission video adjustment report includes including information that designates the important region in the transmission video adjustment report.

### Supplementary Note 19

A non-transitory computer-readable medium configured to store a program that causes a computer to perform a process including:
obtaining a first video and a second video that are different in an imaging position from each other;
determining a video having a higher degree of importance on the basis of the first video and the second video; and
transmitting a transmission video adjustment report to adjust qualities of the first video and the second video, the transmission video adjustment report being used to adjust the qualities of the first video and the second video in accordance with a result of determining a degree of importance.

### Reference Signs List

10 REMOTE MONITORING SYSTEM
12 VIDEO RECEPTION MEANS
13 IMPORTANT VIDEO DETERMINATION MEANS
14 VIDEO ADJUSTMENT REPORT MEANS
15 FIRST VIDEO ADJUSTMENT MEANS
16 SECOND VIDEO ADJUSTMENT MEANS
100 REMOTE MONITORING SYSTEM
101 REMOTE MONITORING APPARATUS
102 NETWORK
111 VIDEO RECEPTION UNIT
112 MONITORING SCREEN DISPLAY UNIT
113 OBJECT DETECTION UNIT
114 IMPORTANT VIDEO DETERMINATION UNIT
115 VIDEO ADJUSTMENT REPORT UNIT
200 VEHICLE
250 ON-ROAD FACILITY
300 COMMUNICATION DEVICE
301 DISTRIBUTED VIDEO ADJUSTMENT UNIT
302 VIDEO TRANSMISSION UNIT
303 ADJUSTMENT REPORT RECEPTION UNIT
350 CAMERA

What is claimed is:

1. A remote monitoring system comprising:
at least one memory storing instructions, and
at least one processor configured to execute the instructions to implement:
a video reception unit configured to obtain a first video and a second video that are different in an imaging position from each other;
an important video determination unit configured to determine a video having a higher degree of importance on the basis of the first video and the second video;
a video adjustment report unit configured to transmit a transmission video adjustment report that is used to adjust qualities of the first video and the second video in accordance with a result of determining a degree of importance;
a first video adjustment unit configured to adjust the first video on the basis of the transmission video adjustment report; and
a second video adjustment unit configured to adjust the second video on the basis of the transmission video adjustment report.

2. The remote monitoring system according to claim 1, wherein the video adjustment report unit is configured to control the first video adjustment unit and the second video adjustment unit on the basis of the transmission video adjustment report to cause a video that has been determined to be the video having the higher degree of importance to have an image quality that is higher than an image quality of a video that has not been determined to be the video having the higher degree of importance.

3. The remote monitoring system according to claim 1, wherein the first video and the second video include at least one of a video obtained in a vehicle to be monitored or a video obtained in a related object relating to the vehicle to be monitored.

4. The remote monitoring system according to claim 1, wherein
the important video determination unit is further configured to determine an important region in each video received by the video reception unit on the basis of each of the videos, and
the video adjustment report unit is configured to include information that designates the important region in the transmission video adjustment report.

5. The remote monitoring system according to claim 1, the at least one processor is further configured to execute the instructions to implement an object detection unit configured to perform object detection on a video received by the video reception unit,
wherein the important video determination unit is configured to determine the video having the higher degree of importance on the basis of a result of the object detection performed by the object detection unit.

6. The remote monitoring system according to claim 5, wherein the important video determination unit is configured to estimate a destination of movement of an object that has been detected, and determine that a video having an imaging range that the destination of movement that has been estimated falls within is the video having the higher degree of importance.

7. The remote monitoring system according to claim 1, wherein the important video determination unit is configured to analyze a state of traffic on the basis of the first video, the second video, and a plurality of the imaging positions of the first video and the second video, and determine the video having the higher degree of importance on the basis of a result of analysis.

8. The remote monitoring system according to claim 1, wherein
the video reception unit is configured to receive one or more videos from respective one or more on-road facilities, and
the important video determination unit is configured to determine that from among the one or more videos that have been received from the respective one or more on-road facilities, a video indicating a traveling direction of a vehicle to be monitored is the video having the higher degree of importance.

9. A remote monitoring apparatus comprising:
at least one memory storing instructions, and
at least one processor configured to execute the instructions to:
obtain a first video and a second video that are different in an imaging position from each other;
determine a video having a higher degree of importance on the basis of the first video and the second video; and
transmit a transmission video adjustment report to adjust qualities of the first video and the second video, the transmission video adjustment report being used to adjust the qualities of the first video and the second video on the basis of a result of determining a degree of importance.

10. The remote monitoring apparatus according to claim 9, wherein the at least one processor is configured to execute the instructions to adjust the qualities of the first video and the second video on the basis of the transmission video adjustment report to cause a video that has been determined to be the video having the higher degree of importance to have an image quality that is higher than an image quality of a video that has not been determined to be the video having the higher degree of importance.

11. The remote monitoring apparatus according to claim 9, wherein the first video and the second video include at least one of a video obtained in a vehicle to be monitored or a video obtained in a related object relating to the vehicle to be monitored.

12. The remote monitoring apparatus according to claim 9, wherein
the at least one processor is further configured to execute the instructions to determine an important region in each video received by the video reception unit on the basis of each of the videos, and
the at least one processor is configured to execute the instructions to include information that designates the important region in the transmission video adjustment report.

13. A remote monitoring method comprising:
obtaining a first video and a second video that are different in an imaging position from each other;
determining a video having a higher degree of importance on the basis of the first video and the second video; and
transmitting a transmission video adjustment report to adjust qualities of the first video and the second video, the transmission video adjustment report being used to adjust the qualities of the first video and the second video in accordance with a result of determining a degree of importance.

14. The remote monitoring method according to claim 13, wherein in adjusting the qualities of the first video and the second video, the qualities of the first video and the second video are adjusted on the basis of the transmission video adjustment report to cause a video that has been determined to be the video having the higher degree of importance to have an image quality that is higher than an image quality of a video that has not been determined to be the video having the higher degree of importance.

15. The remote monitoring method according to claim 13, wherein the first video and the second video include at least one of a video obtained in a vehicle to be monitored or a video obtained in a related object relating to the vehicle to be monitored.

16. The remote monitoring method according to claim 13, further comprising further determining an important region in each video on the basis of the first video and the second video,
generating the transmission video adjustment report includes including information that designates the important region in the transmission video adjustment report.

17. (canceled)
